(19) United States
(12) Patent Application Publication
(10) Pub. No.: US 2026/0366701 A1
(43) Pub. Date: Nov. 19, 2026

(54) METHOD OF CONTROLLING SWITCHES AND SWITCHES THEREFOR

(71) Applicants: Hyundai Motor Company, Seoul (KR); Kia Corporation, Seoul (KR)

(72) Inventors: Jun Geun OH, Hwaseong-Si (KR); Kyu Rok KIM, Hwaseong-Si (KR)

(21) Appl. No.: 19/400,625

(22) Filed: Nov. 25, 2025

(30) Foreign Application Priority Data
May 14, 2025 (KR) 10-2025-0062736

(51) Int. Cl. F21V 11/08; G07C 5/02; F21W 111/00

(52) U.S. Cl. CPC F21V 11/08; G07C 5/02; F21W 2111/00

(57) ABSTRACT

Disclosed are a switch control method including acquiring, by a controller, information reflecting states of a vehicle, and performing control, by the controller, based on the acquired state information of the vehicle, to activate switches that are currently necessary or available in the vehicle and to deactivate switches that are currently unnecessary or unavailable in the vehicle, and a switch therefor.

### CROSS-REFERENCE TO RELATED APPLICATION(S)

This application claims the benefit of priority under 35 U.S.C. 119 to Korean Patent Application No. 10-2025-0062736, filed on May 14, 2025, in the Korean Intellectual Property Office, the disclosure of which is herein incorporated by reference in its entirety.

### TECHNICAL FIELD

The disclosed example relates to a switch control method capable of visually displaying or operating only the necessary switch information depending on the driving situation and state of the vehicle and performing control such that the symbol is not visible when the LED is turned off under the switch non-use condition, and a switch therefor.

### BACKGROUND

The matters described in this Background section are only for enhancement of understanding of the background of the disclosure, and should not be taken as acknowledgment that they correspond to prior art already known to those skilled in the art.

A touch-operated switch provided inside the vehicle cabin may be broadly classified into physical (PUSH-RETURN) and touch/haptic types.

The physical (PUSH-RETURN) type may operate by physically pressing the switch, and require an exterior parting area and a separate piece for each button.

The button symbol may be coated with white paint, and the symbol

on the exterior part is always visible regardless of on/off operation of the LED.

Touch recognition methods may include capacitive and resistive methods.

The capacitive method recognizes a change in capacitance when the touch part is pressed by a finger, and the resistive method recognizes pressure exceeding a certain force applied to the touch part.

Additionally, the haptic method generates vibration of the touch part using an internal motor to provide switch operation feedback.

When the pressure exceeds a threshold value, push haptic feedback is generated, and when the pressure is below the threshold value, release haptic feedback is generated.

In the touch/haptic method, there is no visual separation of areas such as parting lines between symbols, so it is necessary to press the touch boundary of the symbol precisely, and when the switch LED is turned on, all symbols are illuminated simultaneously, and even when the LED is turned off, the symbols remain visible on the exterior.

As such, switches may provide all switch information regardless of the usage condition, which may result in providing excessive switch information to the user, making it difficult to determine the locations of the switch symbols and causing an erroneous operation situation where the symbol of an adjacent switch is pressed by mistake during switch operation while driving.

In addition, even if the switch LED is turned off under the non-use condition of the switch, the symbol remains visible on the

exterior, which may reduce the aesthetic premium quality of the design and surface treatment.

### SUMMARY

The disclosed example is to provide a switch control method capable of visually displaying or operating only necessary switch information depending on the driving situation and state of a vehicle, and a switch therefor.

In addition, the disclosed example is to provide a switch control method capable of performing control such that the symbol is not visible when the LED is turned off under the non-use condition of the switch, and a switch therefor.

The technical subjects pursued in examples set forth herein may not be limited to the above-mentioned technical subjects, and other technical subjects which are not mentioned herein may be clearly understood from the following description by those skilled in the art to which the examples pertain.

According to the present disclosure, a method performed by an apparatus of a vehicle may comprise obtaining state information indicating states of the vehicle, and, based on the obtained state information of the vehicle, controlling a plurality of switches of the vehicle by activating a first switch of the plurality of switches by displaying a first symbol associated with the first switch, wherein the first switch is associated with a first function that is currently necessary or available in the vehicle, and deactivating a second switch of the plurality of switches by hiding a second symbol associated with the second switch, wherein the second switch is associated with a second function that is currently unnecessary or

unavailable in the vehicle.

The method may further comprise emitting light from a light source toward the first switch, passing the light through a transparent molded section and a film layer of the first switch, illuminating the first symbol disposed along a path of the light on the transparent molded section of the first switch such that the illuminated first symbol, on a surface of the first switch, is visible to a user of the vehicle, and blocking the light with a blocking section formed of opaque material such that the light is prevented from leaking to the second switch. The method may further comprise enabling the first function associated with the first switch to activate the first switch, and disabling the second function associated with the second switch to deactivate the second switch.

The method may further comprise activating the plurality of switches based on a gear lever of the vehicle being engaged in a parking position and the vehicle being in a state ready for driving. The method may further comprise activating the plurality of switches based on at least one door of the vehicle being unlocked and the vehicle being in a state ready for driving. The method may further comprise deactivating switches, among the plurality of switches, associated with a door opening function based on a gear lever of the vehicle being engaged in positions other than a parking position, the vehicle being in a state ready for driving, and all doors of the vehicle being locked.

The method may further comprise that all the doors are locked based on a speed of the vehicle being equal to or more than a predetermined speed and the gear lever being engaged in a drive position. The method may further comprise deactivating switches,

among the plurality of switches, associated with driving and parking-related functions based on the vehicle being powered on and not being in a state ready for driving. The method may further comprise deactivating switches of the plurality of switches based on a utility mode of the vehicle being selected to use a vehicle interior for a non-driving purpose and the vehicle being in a power-off state.

The method may further comprise that the deactivated switches are unrelated to an air conditioning function of the vehicle, and that the air conditioning function of the vehicle is activated in the utility mode. The method may further comprise assigning unique identification numbers to respective switch functions associated with the plurality of switches, and configuring the plurality of switches such that only functions of switches corresponding to the unique identification numbers are executed in the vehicle.

The method may further comprise that a variant code is input for each vehicle option, that switch specifications to be operated in the vehicle are configured in the variant code, and that only switches corresponding to the switch specifications configured in the variant code are activated.

According to the present disclosure, a switch may comprise a transparent molded section formed to be transparent and configured to allow light emitted from a light source to pass through the transparent molded section, a film layer fixed in a shape covering a surface of the transparent molded section, a symbol provided in a path on the transparent molded section where the light passes, and a blocking section formed to be opaque and configured to surround the path to block the light from leaking to adjacent symbols.

The switch may further comprise that the blocking section is

configured as an opaque molded section formed to surround the transparent molded section, and that the opaque molded section is formed by double-injection molding with the transparent molded section.

The switch may further comprise that the symbol is provided between the film layer and the transparent molded section. The switch may further comprise that the blocking section is configured by printing an opaque printed layer on a back surface of the transparent molded section, and that the symbol is formed by cutting the opaque printed layer. The switch may further comprise that the symbol is provided on a back surface of the transparent molded section.

According to the present disclosure, an apparatus of a vehicle may comprise a processor and a memory storing at least one instruction that, when executed by the processor, is configured to cause the apparatus to obtain information indicating a state of the vehicle, wherein the information may comprise at least one of a gear lever position, a door lock state, or a power state, determine, based on the obtained information, whether at least one switch among a plurality of switches arranged on a switch panel of the vehicle is usable, based on the at least one switch being determined to be usable, activate the at least one switch by enabling a function of the switch and visually displaying a symbol associated with the switch, and, based on the at least one switch being determined to be unusable, deactivate the switch by disabling the function of the switch and hiding the symbol associated with the switch.

The apparatus may further comprise that the at least one instruction, when executed by the processor, is configured to cause the apparatus to, based on the gear lever position being in a drive

position and doors of the vehicle being locked, deactivate switches, among the plurality of switches, associated with door-related functions.

The apparatus may further comprise that the at least one instruction, when executed by the processor, is configured to prevent illumination of symbols associated with deactivated switches among the plurality of switches by blocking light from leaking to symbols of adjacent switches on the switch panel of the vehicle.

Advantageous effects obtainable from examples set forth herein may not be limited to the above-mentioned effects, and other effects which are not mentioned herein may be clearly understood from the following description by those skilled in the art to which the examples pertain.

### BRIEF DESCRIPTION OF THE DRAWINGS

The above and other examples, features, and advantages of the present disclosure will be more apparent from the following detailed description taken in conjunction with the accompanying drawings, in which:

FIG. 1 shows an example of a state where symbols are displayed on a switch panel unit of a console according to an example of the present disclosure;

FIG. 2 shows an example of a state where symbols are hidden on a switch panel unit of a console according to an example of the present disclosure;

FIG. 3 shows an example of a state where all switch symbols are displayed according to an example of the present disclosure;

FIG. 4 shows an example of a state where only door switch

symbols are hidden according to an example of the present disclosure;

FIG. 5 shows an example of a state where a driving/parking-related switch symbol is hidden according to an example of the present disclosure;

FIG. 6 shows an example of the operation of turning on/off door switch symbols according to an example of the present disclosure;

FIG. 7 shows an example of switches and symbol shapes arranged on a crash pad according to an example of the present disclosure;

FIG. 8 shows an example of switches and symbol shapes arranged on a console according to an example of the present disclosure;

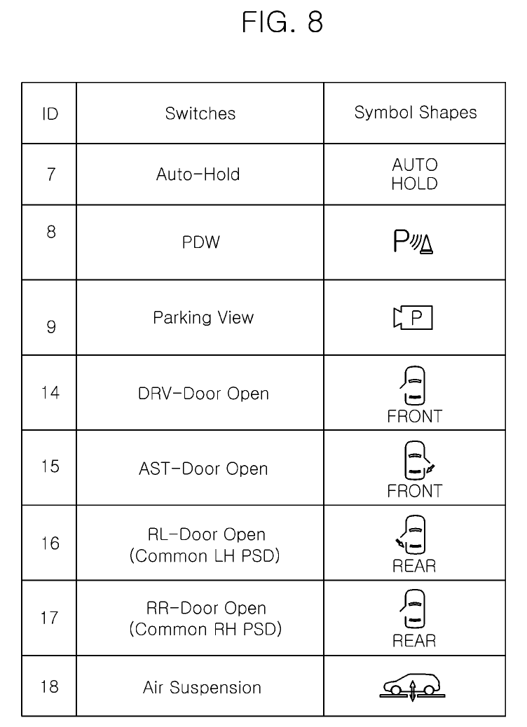

FIG. 9 shows an example of a structure of a switch panel unit according to an example of the present disclosure;

FIG. 10 shows an example of a structural of a switch panel unit according to another example of the present disclosure; and

FIG. 11 shows an example computing system (e.g., a computing device of a vehicle or any other apparatus).

### DETAILED DESCRIPTION

In describing the examples set forth herein, a detailed description of known functions or configurations incorporated herein will be omitted when it is determined that the description may make the subject matter of the examples set forth herein unclear. In addition, it should be appreciated that the accompanying drawings are provided only for the sake of easy understanding of the examples set forth herein, and the technical idea of the present disclosure is not limited to the accompanying drawings and includes all modifications, equivalents, or alternatives falling within the spirit and scope of the present disclosure. The following descriptions are

not intended to limit the present disclosure to the described form or specific field, and it is considered that various alternative modifications and changes may be made to the present disclosure regardless of whether the descriptions are explicit or implicit. Those skilled in the art to which the present disclosure pertains will appreciate that the contents of the present disclosure may be changed in forms and details.

The present disclosure will be described with reference to particular examples. However, as understood by a person ordinarily skilled in the art to which the present disclosure pertains, the various examples set forth herein may be modified or implemented otherwise in different ways without departing from the spirit and scope of the present disclosure. Accordingly, the following description is to be considered illustrative, and is intended to teach those skilled in the art to which the present disclosure pertains how to make and use various examples. It will be appreciated that the forms of the present disclosure illustrated and described herein are to be taken as examples. Equivalent elements, materials, processes, or steps may be substituted for those exemplified and described in the present disclosure. As used in the present disclosure, such expressions as “including,” “comprising,” “incorporating,” “consisting of,” “have,” or “is” should be interpreted in a non-exclusive manner, that is, interpreted to allow for the inclusion of items, components, or elements not explicitly enumerated. In addition, references to the singular form should be interpreted to include the plural form as well.

For purposes of this application and the claims, using the exemplary phrase “at least one of: A; B; or C” or “at least

one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Furthermore, various examples set forth herein should be regarded as illustrative and descriptive, and should not be construed as limiting the details of the present disclosure. All references to joining (e.g., attached, affixed, coupled, and connected) are used only to facilitate understanding of the present disclosure, and are not intended to limit the position, orientation, or use of any component or methods set forth herein. Accordingly, references to joining should be interpreted broadly, if any. Moreover, these references to joining do not imply that two or more elements are connected directly to each other. Additionally, all numerical terms, such as “first,” “second,” “third,” “primary,” “secondary,” “main,” or any other generic terms or numerical expressions, are to be understood solely as identifiers to aid in the understanding of the various components, examples, modifications, or variations of the present disclosure, and do not imply any limitations as to any component, example, modification, variation, or their order or preference. That is, these terms may be used to describe various elements, but the elements are not be limited by the terms. The above terms are used merely for the purpose of distinguishing one element from other elements.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such

combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers

that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In the case where an element is referred to as being "connected" or "coupled" to any other elements, it should be understood that not only the element may be directly connected or coupled to the other elements, but also another element may exist therebetween. Contrarily, in the case where an element is referred to as being "directly connected" or "directly coupled" to any other element, it should be understood that no other element exists therebetween.

In addition, a unit or a control unit included in names is merely a term widely used for naming a controller configured to control a specific function of a vehicle, but does not mean a generic function unit.

In order to control functions in charge, a controller may include a communication device configured to communicate with a sensor or another controller, a memory configured to store an operating system or logic instructions and input/output information, and at least one processor configured to perform determination, calculation, decision, or the like required for control of the functions in charge.

An automation level of an autonomous driving vehicle may be classified as follows, according to the American Society of

Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification

standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

The feature of context-aware switch activation and symbol display in a vehicle may be controlled based on one or more features associated with autonomous driving control, which may be activated according to configured autonomous driving control setting(s) (e.g., based on at least one of: an autonomous driving classification, a selection of an autonomous driving level for a vehicle, etc.). For example, when a higher autonomous driving classification is selected, switches unrelated to passenger operation (e.g., gear shifting, parking, or braking switches, etc.) may be deactivated and their symbols hidden, while passenger-relevant switches (e.g., climate control, infotainment, or seat access switches, etc.) may be activated and displayed. Conversely, when the autonomous driving level is lowered or manual control is restored, the previously deactivated driving-related switches may be reactivated and displayed. By dynamically controlling the activation and symbol display of switches based on autonomous driving control features, the system enhances usability, situational awareness, and safety.

The feature of context-aware switch activation and symbol display in a vehicle may also be controlled based on one or more auxiliary devices (e.g., engine brake, exhaust brake, hydraulic retarder, electric retarder, regenerative brake, etc.). For example, when a regenerative brake is engaged, an energy recovery or battery management switch may be activated and displayed, while unrelated switches (e.g., infotainment or parking switches, etc.) may be deactivated. Similarly, when an engine brake or exhaust brake is active during downhill driving, switches associated with driving safety or braking assistance may be activated and displayed to the driver. By linking switch activation and symbol display to auxiliary device operation, the system ensures that switches most relevant to the current driving context are emphasized, thereby improving usability, situational awareness, and safety.

The feature of context-aware switch activation and symbol display in a vehicle may also be controlled based on one or more communication devices (e.g., a modem, a network adapter, a radio transceiver, an antenna, etc.) that are capable of communicating via wired or wireless communication protocols such as Ethernet, Wi-Fi, near-field communication (NFC), Bluetooth, Long-Term Evolution (LTE), 5G New Radio (NR), or vehicle-to-everything (V2X). For example, when the vehicle receives information via a V2X communication that a nearby intersection is congested, switches related to navigation or route guidance may be activated and displayed. Similarly, when the vehicle connects to an external charging station via NFC or Wi-Fi, charging-related switches may be activated, while unrelated switches (e.g., driving or parking switches, etc.) may be deactivated and hidden. By linking switch activation and symbol display to real-time communication inputs, the system enables adaptive control that enhances usability, connectivity, and situational awareness.

The feature of context-aware switch activation and symbol display in a vehicle may also be controlled based on minimum risk maneuver (MRM) operation(s). A minimal risk maneuver operation (e.g., a minimal risk maneuver, a minimum risk maneuver) may be a maneuvering operation of a vehicle to minimize a risk of collision with surrounding vehicles in order to reach a lowered (e.g., minimum) risk state. During such an operation, the vehicle control apparatus may selectively activate switches relevant to safety and driver awareness (e.g., hazard light switch, emergency call switch, or seatbelt-related switches, etc.) while deactivating switches unrelated to the maneuver (e.g., infotainment or comfort-related switches, etc.). A minimal risk maneuver may be an operation that is activated during autonomous driving of the vehicle when a driver is unable to respond to a request to intervene. During the minimal risk maneuver, one or more processors of the vehicle may thus control the driving operation of the vehicle for a set period of time while ensuring that only safety-critical switches are activated and displayed, thereby reducing distraction and improving situational awareness.

The feature of context-aware switch activation and symbol display in a vehicle may also be controlled, for example, based on biased driving operation(s). For instance, when a biased driving control adjusts the vehicle to maintain a lateral distance offset from the lane center (e.g., during a lane change, obstacle avoidance, or to increase spacing from adjacent vehicles, etc.), the vehicle control apparatus may selectively activate or deactivate switches relevant to the maneuver. For example, when the vehicle is biased toward a lane edge, lane-keeping assist or blind-spot monitoring switches may be activated and displayed, while switches unrelated to the maneuver (e.g., parking or charging switches, etc.) may be deactivated and hidden. By dynamically adjusting switch activation and symbol display according to biased driving operations, the system enhances usability, ensures that safety-critical switches are emphasized, and reduces distraction during lateral adjustment maneuvers.

One or more sensors (e.g., IMU sensors, camera, LiDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may be used to control, for example, the feature of context-aware switch activation and symbol display in a vehicle described herein. In particular, the vehicle control apparatus may dynamically activate switches relevant to the detected state (e.g., activating wiper switches when rain is detected, enabling seatbelt-related switches when a seatbelt is unfastened, or activating charging-related switches when the charging interface is connected, etc.) while deactivating switches unrelated to the current sensor-detected condition. By doing so, sensor-based control improves safety, reduces distraction, and enhances the adaptability of the switch interface to real-time driving and environmental conditions.

The feature of context-aware switch activation and symbol display in a vehicle may be controlled based on an autonomous driving level and/or autonomous driving activation/deactivation. For example, a driving control apparatus may determine the autonomous driving level (e.g., L2, L3, or L4, etc.) or whether autonomous driving is currently active, and selectively activate or deactivate switches accordingly. In a higher autonomous driving level or when autonomous driving is active, switches unrelated to passenger use (e.g., gear selection, parking, or auto-hold switches, etc.) may be deactivated and their symbols hidden, while passenger-relevant switches (e.g., climate control, infotainment, or door access switches, etc.) remain activated and displayed. Conversely, in a lower autonomous driving level or when autonomous driving is deactivated, driving-related switches may be reactivated and displayed to ensure they are immediately available for manual driving. By dynamically controlling the switch activation and symbol display based on the autonomous driving level, the system enhances usability, reduces distraction, and improves safety.

Any number or variety of components in any of the configurations set forth herein may fall within the scope of the present disclosure set forth herein. The components may include any combination of the features set forth herein and may be arranged in any of various configurations set forth herein. The concepts related to the uses and operations of the components of the present disclosure, as well as their structures and arrangements, may be applied to any number of examples in any combination, as well as to the particular examples discussed herein. Examples including those having various features in various arrangements are described below with reference to the drawings.

According to the present disclosure, a vehicle switch control apparatus may be provided that improves usability and quality by selectively displaying and activating only switches applicable for a given driving situation. If all switches remain visible at all times, they may cause confusion, mis operation, or aesthetic degradation when symbols for unused functions are displayed. To address this, the present disclosure provides touch or haptic switches equipped with LED-based symbols that may appear or disappear depending on the operating state of the vehicle. For example, when the vehicle is in motion, door-opening switches may be hidden for safety, while when the vehicle is parked, all switches may be made visible and operable. In other situations, such as a power-on but non-driving state or a utility mode (e.g., theater or camping mode), driving-related switches or parking-related switches may be automatically deactivated and hidden. Further, structural features such as transparent molded sections, film layers, and opaque blocking sections may be employed to ensure that only the relevant symbols are illuminated without light leakage, thereby maintaining a uniform exterior surface and preventing adjacent symbols from becoming visible. Through such selective activation and symbol control, operational usability, safety, and surface uniformity of vehicle switch panels may be enhanced.

Furthermore, different switches may be illuminated or activated based on changes in the autonomous driving level or mode. Different switches may also be illuminated or activated depending on a driving-mode change or an emergency driving mode (e.g., MRM). In some cases, certain switches may be illuminated and may blink to indicate activation (e.g., to signal that manual driving mode needs to be activated, that an emergency driving mode has been activated, or that a switch can override an autonomous driving mode, etc.).

Hereinafter, various examples set forth herein will be described in detail with reference to the accompanying drawings, and the same or similar elements are given the same and similar reference numerals regardless of figure numbers, so duplicate descriptions thereof will be omitted.

A switch control method according to the present disclosure may include acquiring, by a controller C, information reflecting the state of a vehicle (e.g., gear lever position, door lock status, or power state, etc.), and performing control, by the controller C, based on the acquired vehicle state information, such that switches that are currently necessary for the vehicle or available for use are activated while switches that are currently unnecessary for the vehicle or unavailable for use are deactivated (e.g., disabling door switches during driving, enabling climate switches in utility mode, or deactivating parking switches when the vehicle is not in the P position, etc.).

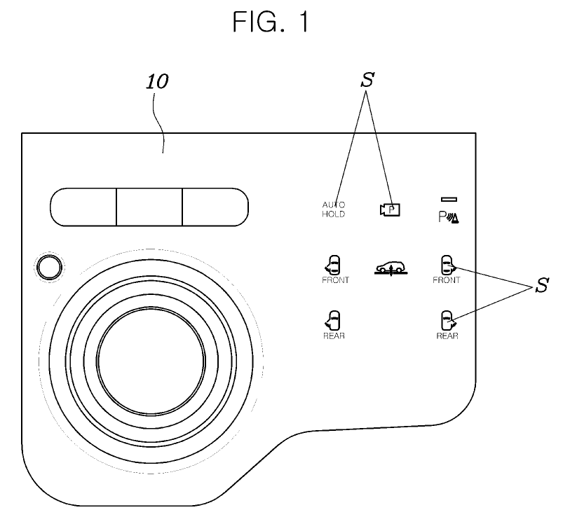

Referring to FIG. 1, switches of the present disclosure are touch/haptic-type switches that may be provided on a console or crash pad of a vehicle capable of EV mode driving, and may be operated by touch (e.g., fingertip touch, swipe, or press with haptic vibration, etc.).

Multiple switches are arranged on a single switch body, and a symbol S is formed on each switch to convey information for the corresponding switch. The symbol S is visually displayed or hidden based on on/off operation of a switch light source 500 (LED) (e.g., white LED, RGB LED, or infrared LED, etc.).

The information reflecting the vehicle’s state may include information reflecting the position of a gear lever, lock/unlock information of doors, and power information (e.g., battery state of charge, ignition on/off, or EV ready state, etc.), and the controller C may acquire these pieces of information.

Accordingly, the controller C, based on the acquired information, may determine the vehicle’s situation or state and, based on a result of the determination, activate only the switches necessary or available for the user of the vehicle (e.g., enabling door open switches when parked, enabling air suspension switches when in off-road mode, or enabling climate switches in utility mode, etc.).

As an example of activating the switch, the symbol S may be displayed on the surface of the switch to indicate activation, and, as an example of deactivating the switch, the symbol S may be hidden on the surface of the switch to indicate deactivation (e.g., dimming to zero brightness, completely hiding behind an opaque layer, or changing to a neutral color, etc.).

In addition, as another example of activating the switch, the function of the switch may be enabled and activated, and, as another example of deactivating the switch, the function of the switch may be disabled and deactivated (e.g., disabling input detection, cutting off signal transmission, or preventing execution of a command, etc.).

That is, by performing control such that only the symbols S of switches necessary or available for the user are selectively displayed, the information delivery and operational usability of the switches may be improved (e.g., faster recognition, reduced eye distraction, or minimized erroneous operation, etc.).

In addition, by performing control such that the symbols S of switches unnecessary for use are not visible, it is possible to improve the aesthetic premium quality of the design and surface treatment, and to implement a clean image (e.g., seamless glossy panel, matte hidden display, or premium integrated finish, etc.).

Furthermore, even the functions of switches that are unnecessary or unavailable for the user in a certain situation or for safety reasons may be disabled, thereby preventing inconvenience and accidents caused by erroneous touch operations (e.g., accidental child door unlock, unintended parking brake release, or activation of suspension adjustment while driving, etc.).

As an example of the present disclosure, when the vehicle is in a state ready for driving and the gear lever is in the P position, all switches may be activated.

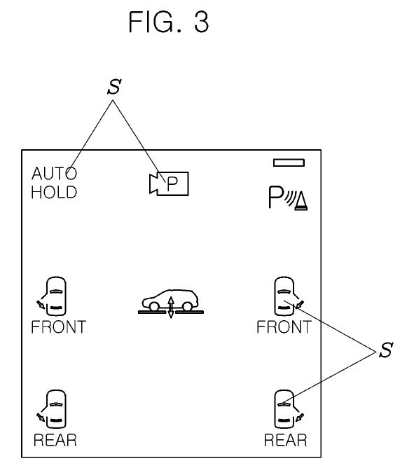

Referring to FIG. 3, the state where the vehicle is ready for driving may be the EV READY-ON or DRIVE READY-ON state in a vehicle capable of EV mode driving (e.g., hybrid mode, plug-in EV start mode, or idle-ready state, etc.).

In this state, when the gear lever is in the P position and the vehicle is stationary, all switches may be activated and displayed.

For example, all symbols S of switches arranged on a console may be displayed, and the switches may include an auto-hold switch, a PDW switch, a parking view switch, a DRV-door open switch, an AST-door open switch, an RL-door open switch (shared with LH PSD), an RR-door open switch (shared with RH PSD), and an air suspension switch (e.g., console may further include hazard light switch, climate control switch, or seat heating switch, etc.).

As another example of the present disclosure, when at least one door is unlocked while the vehicle is in a state ready for driving, all switches may be activated (e.g., door switches, parking-related switches, or air suspension switch, etc.).

Referring to FIG. 3, in the case where any one of the doors is in an unlocked state when the vehicle is in a state ready for driving, all switches may be activated and displayed (e.g., DRV-door open switch, AST-door open switch, RL-door open switch, or RR-door open switch, etc.).

For example, the symbols S of all switches arranged on the console may be displayed, and these switches may be the same as those described above (e.g., DRV-door, AST-door, RL-door, RR-door, or additional door-specific switches, etc.).

As another example of the present disclosure, in the case where one of the gear positions other than P is engaged when the vehicle is in a state ready for driving and where all doors are locked, the door switches may be deactivated (e.g., DRV-door open switch, AST-door open switch, RL-door open switch, or RR-door open switch, etc.).

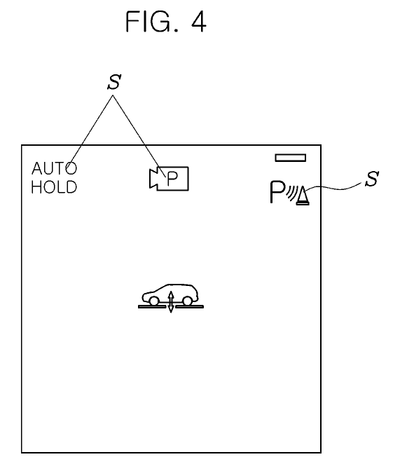

Referring to FIG. 4, in the case where the gear lever is engaged in any one of the D, R, and N positions when the vehicle is in a state ready for driving and where all doors are locked, all door switches may be deactivated (e.g., DRV-door open switch, AST-door open switch, RL-door open switch, or RR-door open switch, etc.).

For example, among the switches arranged on the console, the symbols S of the DRV-door open switch, AST door-open switch, RL-door open switch, and RR-door open switch, which correspond to door switches, may be hidden by deactivation (e.g., graying out icons, disabling backlight, or making icons invisible, etc.).

As a result, the symbols S of the remaining switches, excluding the door switches, may be activated and displayed, so that the activated and displayed symbols S of switches may include the auto-hold switch, PDW switch, parking view switch, and air suspension switch (e.g., active switches may further include hazard warning, infotainment, or navigation-related functions, etc.).

Preferably, when the vehicle speed is equal to or more than a predetermined speed with the gear lever engaged in the D position, all the doors may be locked (e.g., at 15 km/h, 20 km/h, or a manufacturer-set threshold, etc.).

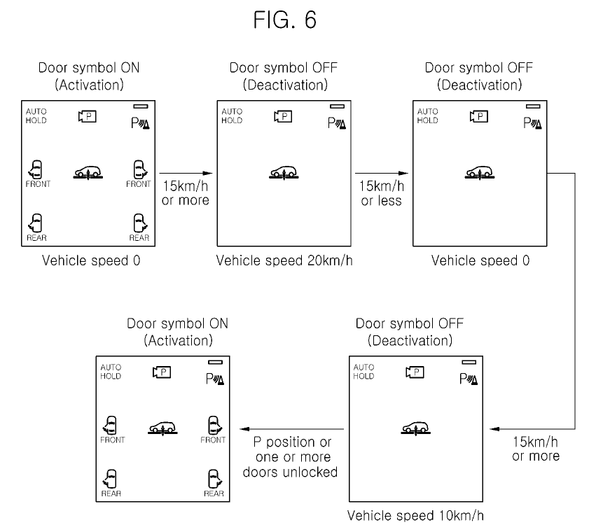

Referring to FIG. 6, when the vehicle is stationary with the gear lever engaged in the P position, the vehicle speed is zero, and the symbols S of all the switches may be activated and displayed (e.g., door switches, parking view switch, or auto-hold switch, etc.).

Subsequently, when the gear lever is engaged in the D position and the vehicle moves forward with a speed of 15 km/h or higher, the doors switch from an unlocked state to a locked state, so that the symbols S of the door switches are deactivated and hidden (e.g., DRV-door open switch, AST-door open switch, RL-door open switch, or RR-door open switch, etc.).

Afterwards, regardless of the vehicle speed, the vehicle continues driving with the door switch symbols S deactivated, and when the gear lever is engaged in the P position at a speed below a predetermined speed or when any one of the doors is unlocked, the symbols S of the door switches may be reactivated and displayed (e.g., when stopping at a traffic light, arriving at a charging station, or unlocking via key fob, etc.).

As another example of the present disclosure, when the vehicle is powered on but not in a state ready for driving, the driving and parking-related switches may be deactivated (e.g., auto-hold switch, parking assist switch, or air suspension switch, etc.).

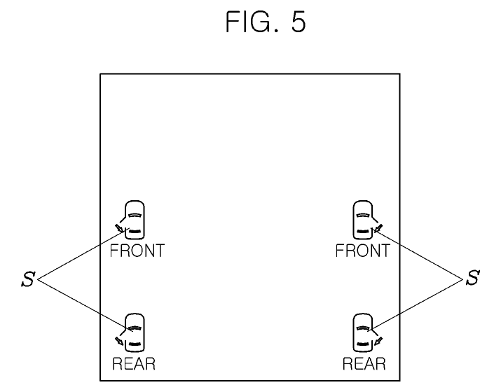

Referring to FIG. 5, this may correspond to an EV READY-OFF or DRIVE READY-OFF state and a POWER-ON state in the capable of EV mode driving.

Since operations such as driving and parking are not possible in such a state, the driving and parking-related switches may be deactivated.

For example, among the switches arranged on the console, the symbols S of the auto-hold switch, PDW switch, parking view switch, and air suspension switch, which correspond to driving and parking-related switches, may be deactivated and hidden (e.g., symbols may disappear, be dimmed, or show as disabled icons, etc.).

As a result, the symbols S of the remaining switches, excluding the driving and parking-related switches, may be activated and displayed, and the activated and displayed symbols S of the switches may include the DRV-door open switch, AST-door open switch, RL-door open switch, and RR-door open switch (e.g., switches related to passenger access, cargo area access, or sliding doors, etc.).

Meanwhile, as another example of the present disclosure, when a utility mode is selected when the vehicle is in a power-off state to utilize the vehicle interior for purposes unrelated to vehicle driving, all of the switches may be deactivated (e.g., console switches, crash pad switches, or center stack switches, etc.).

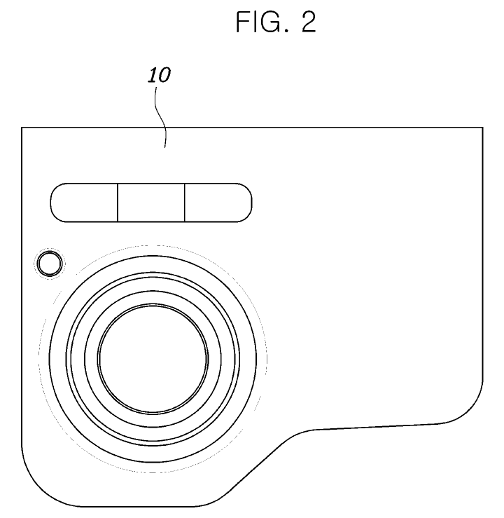

Referring to FIG. 2, the utility mode is a mode that may be selected when the vehicle is in a power-off state and the user needs to engage in activities inside the vehicle or stay inside for an extended duration (e.g., watching movies, sleeping, eating meals, or leaving a pet inside, etc.).

For example, the utility mode may typically include theater mode, auto camping mode, and sleep mode, and may also include pet mode where only a pet remains inside the vehicle (e.g., dog, cat, or another domestic pet, etc.).

In these modes, since operating the switches arranged on the console is unnecessary or impossible for the user due to situational or safety considerations, the symbols S of the switches may be deactivated and hidden (e.g., turned off visually, grayed out, or completely removed from the visible interface, etc.).

Additionally, an air-conditioning function may be activated in the utility mode (e.g., cooling, heating, dehumidifying, or ventilation, etc.).

That is, even though the vehicle is powered off in the utility mode, the air-conditioning system such as a heater or air conditioner may be controlled to operate in response to the user or pet staying in the vehicle for an extended duration (e.g., several hours of resting, sleeping overnight, or keeping a pet comfortable during hot weather, etc.).

Meanwhile, in the present disclosure, configuration may be such that each switch function is assigned a unique ID number, such that IDs of switches applied to the vehicle are transmitted, and such that only the functions of the switches corresponding to the received IDs are executed in the vehicle (e.g., only seat heating switches, trunk opening switches, or suspension height switches, etc.).

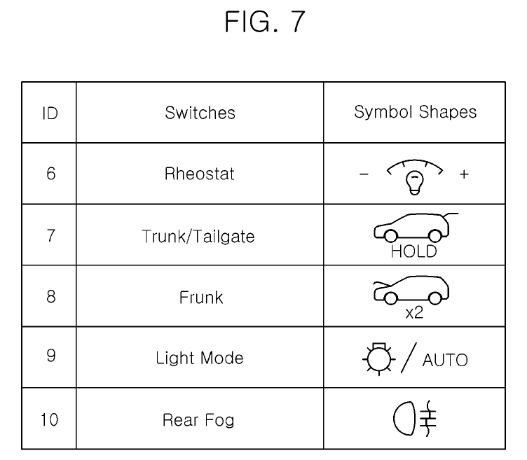

Referring to FIGS. 6 and 7, unique IDs may be assigned to respective switches arranged on the console and respective switches arranged on the crash pad, thereby implementing the switch logic (e.g., IDs may be numeric, alphanumeric, or coded as QR/barcode patterns, etc.).

However, the equipment installed in the vehicle may differ depending on the vehicle specifications and model, and the configuration of switches that implement the functions of the corresponding equipment may also differ (e.g., premium vs. base trim, EV vs. hybrid, or 5-seater vs. 7-seater, etc.).

Accordingly, if only the IDs of the functions necessary for the vehicle specifications and model are transmitted to the switch logic, the transmitted IDs may be received to activate and operate only the corresponding switch functions, while the remaining switch functions may be deactivated and prevented from operating (e.g., trunk switch deactivated in sedan model, sliding door switch deactivated in non-minivan, or air suspension switch deactivated in base trim, etc.).

Accordingly, the operational logic that supports all switch specifications may be implemented by a single switch software, so there is no need to implement a separate switch logic for each vehicle specification and model, thereby significantly reducing the cost (e.g., reduced development cost, simplified software updates, or minimized hardware variation, etc.).

Furthermore, a variant code may be input for each vehicle option, switch specifications to be operated in the vehicle may be configured in the variant code, and only the switches that operate in the relevant vehicle according to the variant code may be activated (e.g., variant codes for trim levels, packages, or region-specific regulations, etc.).

That is, when a specific variant code is input, only the switch configured to match the variant code may be activated (e.g., climate switches for hot-region variant, heated seat switches for cold-region variant, or rear door switches for van variant, etc.).

For example, when a variant code VAR-3KEY is input, three switch functions configured in the variant code may be activated, and the remaining switch functions may be deactivated (e.g., activating only window switches, mirror adjustment switches, and trunk switch, while disabling others, etc.).

In addition, when a variant code VAR-4KEY is input, four switch functions configured in the variant code may be activated, and the remaining switch functions may be deactivated (e.g., four switches for window control, mirror adjustment, trunk release, or hazard lights, etc.).

Furthermore, the activated switches may display their symbols S, and the deactivated switches may hide their symbols S while disabling and deactivating their functions (e.g., disabling power supply, turning off backlighting, or blocking touch input, etc.).

Meanwhile, the switch according to the present disclosure is configured to include a transparent molded section 100 that is formed to be transparent and allows light emitted from a light source 500 to pass through the transparent molded section 100, a film layer 300 that is fixed in a shape covering the surface of the transparent molded section 100, a symbol S that is provided in the path on the transparent molded section 100 where the light passes, and a blocking section that is formed to be opaque and to surround the light transmission path to block light from passing through (e.g., preventing leakage, crosstalk, or ghosting, etc.).

To briefly describe the structure of the switch, the switch may include an upper switch panel unit 10 and a lower switch module section (e.g., formed as stacked assemblies, modular plates, or detachable units, etc.).

The switch module section may include an LED used as a light source 500, a light guide 600 for guiding the light emitted from the LED 500 to the desired illumination area, and a housing and cover including a structure for fixing the light guide 600 and opposing parts, and, if necessary, may include an inner lens for protecting the LED 500 and altering the direction of the light source from the LED 500 (e.g., for beam shaping, diffusion, or glare reduction, etc.).

In addition, the switch module section may further include a steel bracket that transmits vibration generated from the motor throughout the assembly, and a rubber damper that transmits vibration from the switch module section to the switch panel unit 10 (e.g., for haptic feedback, vibration alerts, or tactile confirmation, etc.).

Additionally, an IR sensor may be included to sense pressure, based on a change in the gap distance to each panel position through infrared rays (e.g., capacitive touch combined with IR sensing, proximity sensing, or pressure level detection, etc.).

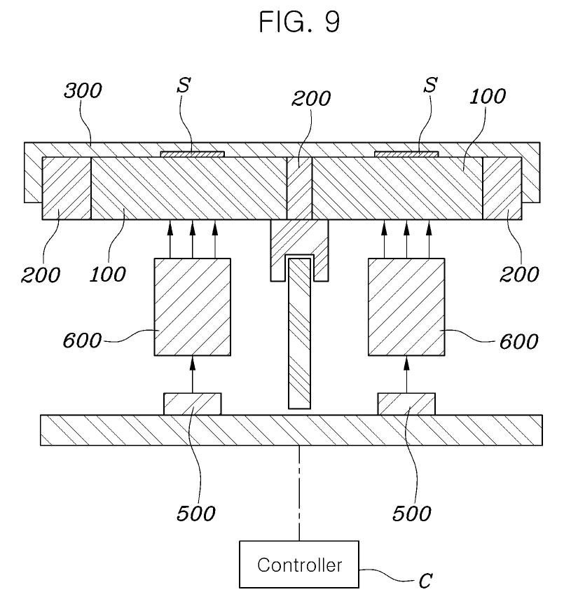

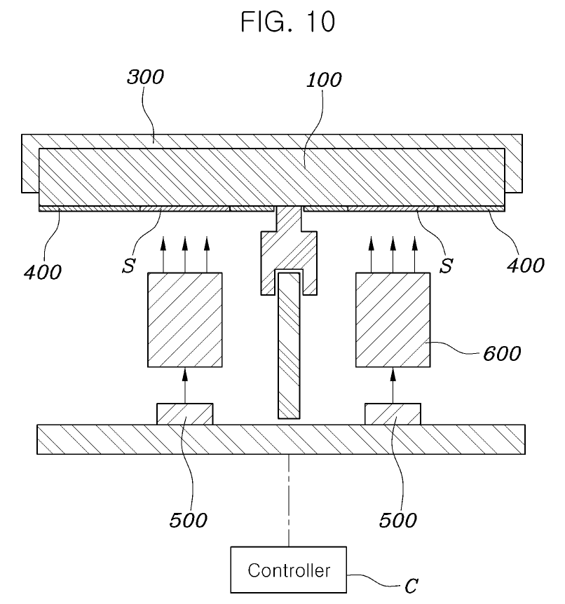

FIGS. 9 and 10 schematically illustrate the configuration of the switch panel unit 10 according to the disclosed example in which a transparent molded section 100 made of a transparent material is provided above the light guide 600 and the transparent molded section 100 is covered with a film layer 300 configured as an IML film

(e.g., in-mold labeling film with decorative pattern, anti-smudge coating, or scratch resistance, etc.).

Accordingly, the light emitted from the LED 500 passes through the light guide 600 and reaches the transparent molded section 100, and the light incident on the transparent molded section 100 passes through the transparent molded section 100 (e.g., without distortion, scattering, or loss of brightness, etc.).

In this case, since the symbol S of the switch is formed in the path on the transparent molded section 100 where the light passes, the light emitted from the LED 500 illuminates the symbol S, making the symbol S visible outside the film layer 300 (e.g., letters, icons, arrows, or pictograms, etc.).

The symbols S are arranged in multiple rows and columns on the switch panel unit 10, and the respective symbols S are arranged at a predetermined distance apart from each other (e.g., 2 mm, 5 mm, or spacing defined by ergonomic standards, etc.).

Specifically, a blocking section is provided to surround the light transmission path from the LED 500, and the blocking section is formed of an opaque material to prevent the light of the LED 500 from passing through the blocking section.

Accordingly, in the case where a specific symbol S is illuminated by the light from the LED 500, the blocking section may prevent the light of the LED 500 from leaking to adjacent symbols S., so that the symbols S of switches that are turned off are completely hidden, thereby providing the switch panel unit 10 with an integrated exterior design and consistent clean design (e.g., premium seamless surface, glass-like touch interface, or hidden-until-lit styling, etc.).

As an example of the blocking section according to the present disclosure, the blocking section may be configured as an opaque molded section 200 formed to surround the transparent molded section 100.

Additionally, the opaque molded section 200 may be formed by double-injection molding with the transparent molded section 100 (e.g., two-shot molding, co-molding, or insert molding, etc.).

Referring to FIG. 9, as shown in the drawing, the opaque molded section 200 is provided in a black-color on the left and right sides of the transparent molded section 100, so that the light from the LED 500 passing through the left transparent molded section 100 is blocked from traveling toward the right transparent molded section 100 by the opaque molded section 200 provided between the left and right transparent molded sections 100 (e.g., blocking lateral leakage, cross-lighting, or unintended glow, etc.).

Similarly, the light from the LED 500 passing through the right transparent molded section 100 may also be blocked from traveling toward the left transparent molded section 100 by the opaque molded section 200 above.

Accordingly, the opaque molded section 200 prevents light from the LED 500 from leaking to adjacent symbols S, and, in particular, the film layer 300 is provided in a shape covering the surface of the opaque molded section 200 as well as the surface of the transparent molded section 100, so the opaque molded section 200 is not visible from the outside, thereby providing a clean design of the switch panel unit 10 (e.g., seamless appearance, hidden border, or glossy uniform finish, etc.).

In addition, in an example of the symbol S according to the present disclosure, the symbol S may be provided between the film layer 300 and the transparent molded section 100 (e.g., embedded icon, back-printed text, or decorative logo, etc.).

Referring to FIG. 9, the symbol S may be formed on the back surface of the film layer 300, and the symbol S may be integrated and molded with the film layer 300 when the film layer 300 is molded (e.g., during in-mold labeling, screen printing, or heat-transfer printing, etc.).

Meanwhile, in another example of the blocking section according to the present disclosure, the blocking section may be configured by printing an opaque printed layer 400 on the back surface of the transparent molded section 100 (e.g., black ink, metallic paint, or ceramic ink, etc.).

In addition, in another example of the symbol S, the symbol S may be provided on the back surface of the transparent molded section 100 (e.g., engraved by laser, etched, or directly printed, etc.).

Furthermore, the symbol S may be formed by cutting the opaque printed layer 400 (e.g., by laser ablation, mechanical cutting, or chemical etching, etc.).

Referring to FIG. 10, as shown in the drawing, a black-colored opaque printed layer 400 may be printed on the back surface of the transparent molded section 100.

In addition, a portion of the opaque printed layer 400 may be laser-cut into the shape of the symbol S, thereby forming the symbol S on a part of the back surface of the transparent molded section 100 (e.g., letters, numbers, icons, or pictograms, etc.).

Accordingly, the light from the LED 500 illuminating the transparent molded section 100 may pass through the laser-cut symbol S and through the transparent molded section 100, so that the light emitted from the LED 500 may illuminate the symbol S, making it visible outside the film layer 300 (e.g., as a bright icon, text, or pictogram, etc.).

However, the light directed onto the opaque printed layer 400 is unable to pass through the opaque printed layer 400, thereby ensuring that the light from the LED 500 is concentrated only on the symbol S and preventing the light from leaking around the symbol S (e.g., avoiding halo effects, ghost images, or blurred illumination, etc.).

In particular, since the opaque printed layer 400 is printed on the back surface of the transparent molded section 100, the opaque printed layer 400 is not visible from the outside, thereby implementing a clean design of the switch panel unit 10 (e.g., flush surface, hidden-until-lit icon, or premium glossy finish, etc.).

As described above, in the present disclosure, by performing control such that only the switch symbols S necessary or available for the user are selectively displayed, it is possible to improve the information delivery and operational usability of the switch (e.g., quicker recognition, reduced distraction, or simplified user interface, etc.).

Furthermore, by performing control such that the symbols S of unnecessary switches are not visible, it is possible to improve the aesthetic premium quality of the design and surface treatment, and to implement a clean image (e.g., premium design language, consistent visual identity, or luxury branding, etc.).

Moreover, even the functions of switches that are unnecessary or unavailable for the user in a certain situation or for safety reasons may be disabled, thereby preventing inconvenience and accidents caused by erroneous touch operations (e.g., accidental child window activation, unintended trunk opening, or suspension adjustment while driving, etc.).

In addition, when a specific symbol S is illuminated by light of the LED 500, it is possible to prevent the light of the LED 500 from leaking to adjacent symbols S so that the symbol S of the switch in an off state is completely hidden, thereby providing the switch panel unit 10 with an integrated exterior design and consistent clean design (e.g., unified styling, improved night-time visibility, or reduced driver distraction, etc.).

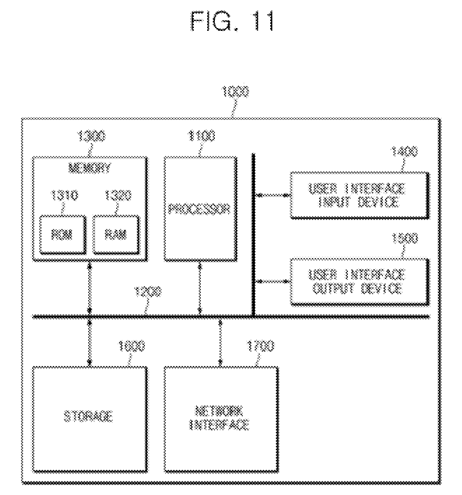

FIG. 11 shows an example computing system (e.g., a computing device of a vehicle or any other apparatus). One or more controllers, processors, etc. described herein, and any other components and devices disclosed herein, may be implemented by or in the computing system as shown in FIG. 11.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example of the present disclosure, there is provided a switch control method including acquiring, by a controller, information reflecting states of a vehicle; and performing control, by the controller, based on the acquired state information of the vehicle, to activate switches that are currently necessary or available in the vehicle and to deactivate switches that are currently unnecessary or unavailable in the vehicle.

The switch may be activated by displaying a symbol on the surface of the switch, and may be deactivated by hiding the symbol on the surface of the switch.

A function of the switch may be enabled to activate the switch, and a function of the switch may be disabled to deactivate the switch.

All switches may be activated in a case where a gear lever is engaged in a P position when the vehicle is in a state ready for driving.

All switches may be activated in a case where at least one door is unlocked when the vehicle is in a state ready for driving.

Door switches may be deactivated in a case where a gear lever is engaged in one of the remaining shift positions, excluding a P position, when the vehicle is in a state ready for driving and where all doors are locked.

All doors may be locked in a case where a vehicle speed is equal to or more than a predetermined speed while the gear lever is engaged in a D position.

Driving and parking-related switches may be deactivated in a case where the vehicle is powered on and is not in a state ready for driving.

All switches may be deactivated in a case where a utility mode is selected to use a vehicle interior for purposes unrelated to vehicle driving when the vehicle is in a power-off state.

An air conditioning function may be activated in the utility mode.

Configuration may be such that each switch function is assigned a unique ID number, such that IDs of switches applied to the vehicle are transmitted, and such that only the functions of the switches corresponding to the received IDs are executed in the vehicle.

A variant code may be input for each vehicle option, and switch specifications to be operated in the vehicle may be configured in the variant code, and only switches that operate in a relevant vehicle according to the variant code may be activated.

According to another example of the present disclosure, there is provided a switch including a transparent molded section formed to be transparent and configured to allow light emitted from a light source to pass therethrough, a film layer fixed in a shape covering a surface of the transparent molded section, a symbol provided in a path on the transparent molded section where the light passes, and a blocking section formed to be opaque and configured to surround the light transmission path to block light from passing therethrough.

The blocking section may be configured as an opaque molded section formed to surround the transparent molded section.

The opaque molded section may be formed by double-injection molding with the transparent molded section

The symbol may be provided between the film layer and the transparent molded section.

The blocking section may be configured by printing an opaque printed layer on a back surface of the transparent molded section.

The symbol may be provided on a back surface of the transparent molded section.

The symbol may be formed by cutting the opaque printed layer.

According to the disclosed example, by performing control such that only the switch symbols necessary or available for the user are selectively displayed, it is possible to improve the information delivery and operational usability of the switch.

Furthermore, by performing control such that the symbols of unnecessary switches are not visible, it is possible to improve the aesthetic premium quality of the design and surface treatment, and to implement a clean image.

Moreover, even the functions of switches that are unnecessary or unavailable for the user in a certain situation or for safety reasons may be disabled, thereby preventing inconvenience and accidents caused by erroneous touch operations.

In addition, when a specific symbol is illuminated by LED light, it is possible to prevent the LED light from leaking to adjacent symbols so that the symbol of the switch in an off state is completely hidden, thereby providing the switch panel unit with an integrated exterior design and consistent clean design.

Although the present disclosure has been described and illustrated in conjunction with particular examples thereof, it will be apparent to those skilled in the art that various improvements and modifications may be made to the present disclosure without departing from the technical idea of the present disclosure defined by the appended claims.

What is claimed is:

1. A method performed by an apparatus of a vehicle, the method comprising:
obtaining state information indicating states of the vehicle; and
based on the obtained state information of the vehicle, controlling a plurality of switches of the vehicle by:
activating a first switch of the plurality of switches by displaying a first symbol associated with the first switch, wherein the first switch is associated with a first function that is currently necessary or available in the vehicle, and
deactivating a second switch of the plurality of switches by hiding a second symbol associated with the second switch, wherein the second switch is associated with a second function that is currently unnecessary or unavailable in the vehicle.

2. The method of claim 1, further comprising: emitting light from a light source toward the first switch;
passing the light through a transparent molded section and a film layer of the first switch;
illuminating the first symbol disposed along a path of the light on the transparent molded section of the first switch such that the illuminated first symbol, on a surface of the first switch, is visible to a user of the vehicle; and
blocking the light with a blocking section formed of opaque material such that the light is prevented from leaking to the second switch.

3. The method of claim 1, further comprising:
enabling the first function associated with the first switch to activate the first switch; and
disabling the second function associated with the second switch to deactivate the second switch.

4. The method of claim 1, further comprising:
activating the plurality of switches based on a gear lever of the vehicle being engaged in a parking position and the vehicle being in a state ready for driving.

5. The method of claim 1, further comprising:
activating the plurality of switches based on at least one door of the vehicle being unlocked and the vehicle being in a state ready for driving.

6. The method of claim 1, further comprising:
deactivating switches, among the plurality of switches, associated with a door opening function based on:
a gear lever of the vehicle being engaged in positions other than a parking position,
the vehicle being in a state ready for driving, and
all doors of the vehicle being locked.

7. The method of claim 6, wherein all the doors are locked based on a speed of the vehicle being equal to or more than a predetermined speed and the gear lever being engaged in a drive position.

8. The method of claim 1, further comprising:
deactivating switches, among the plurality of switches, associated with driving and parking-related functions, based on the vehicle being powered on and not being in a state ready for driving.

9. The method of claim 1, further comprising:
deactivating switches of the plurality of switches based on a utility mode of the vehicle being selected to use a vehicle interior for a non-driving purpose and the vehicle being in a power-off state.

10. The method of claim 9, wherein the deactivated switches are unrelated to an air conditioning function of the vehicle, and wherein the air conditioning function of the vehicle is activated in the utility mode.

11. The method of claim 1, further comprising:
assigning unique identification numbers to respective switch functions associated with the plurality of switches; and
configuring the plurality of switches such that only functions of switches corresponding to the unique identification numbers are executed in the vehicle.

12. The method of claim 11,
wherein a variant code is input for each vehicle option,
wherein switch specifications to be operated in the vehicle are configured in the variant code, and
wherein only switches corresponding to the switch specifications configured in the variant code are activated.

13. A switch comprising:
a transparent molded section formed to be transparent and configured to allow light emitted from a light source to pass through the transparent molded section;
a film layer fixed in a shape covering a surface of the transparent molded section;
a symbol provided in a path on the transparent molded section where the light passes; and
a blocking section formed to be opaque and configured to surround the path to block the light from leaking to adjacent symbols.

14. The switch of claim 13, wherein the blocking section is configured as an opaque molded section formed to surround the transparent molded section, and wherein the opaque molded section is formed by double-injection molding with the transparent molded section.

15. The switch of claim 13, wherein the symbol is provided between the film layer and the transparent molded section.

16. The switch of claim 13, wherein the blocking section is configured by printing an opaque printed layer on a back surface of the transparent molded section, and wherein the symbol is formed by cutting the opaque printed layer.

17. The switch of claim 13,
wherein the symbol is provided on a back surface of the transparent molded section.

18. An apparatus of a vehicle, the apparatus comprising:
a processor; and
a memory storing at least one instruction that, when executed by the processor, is configured to cause the apparatus to:
obtain information indicating a state of the vehicle, wherein the information comprises at least one of a gear lever position, a door lock state, or a power state,
determine, based on the obtained information, whether at least one switch among a plurality of switches arranged on a switch panel of the vehicle is usable,
based on the at least one switch being determined to be usable, activate the at least one switch by enabling a function of the switch and visually displaying a symbol associated with the switch, and
based on the at least one switch being determined to be unusable, deactivate the switch by disabling the function of the switch and hiding the symbol associated with the switch.

19. The apparatus of claim 18, wherein the at least one instruction, when executed by the processor, is configured to cause the apparatus to, based on the gear lever position being in a drive position and doors of the vehicle being locked, deactivate switches, among the plurality of switches, associated with door-related functions.

20. The apparatus of claim 18, wherein the at least one instruction, when executed by the processor, is configured to prevent illumination of symbols associated with deactivated switches among the plurality of switches by blocking light from leaking to symbols of adjacent switches on the switch panel of the vehicle.
